(19) United States
(12) Patent Application Publication
(10) Pub. No.: US 2025/0055924 A1
(43) Pub. Date: Feb. 13, 2025

(54) USER IDENTIFICATION METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Peng FAN, Shenzhen (CN)

(21) Appl. No.: 18/928,139

(22) Filed: Oct. 27, 2024

Related U.S. Application Data
(63) Continuation of application No. PCT/CN2023/127252, filed on Oct. 27, 2023.

(30) Foreign Application Priority Data
Nov. 23, 2022 (CN) 202211477548.6

(51) Int. Cl. H04L 67/306; H04N 7/15

(52) U.S. Cl. CPC H04L 67/306; H04N 7/15

(57) ABSTRACT

This application discloses a user identification method. The method includes obtaining a plurality of users of an application program; generating, an account feature and a service feature of a user, the account feature being based on account use information of the user in the application program, and the service feature being based on a historical payment-related behavior of the user; aggregating account features in a plurality of time dimensions to obtain a target account feature; aggregating service features in the plurality of time dimensions to obtain a target service feature; generating a user feature of the user based on the target account feature and the target service feature; and inputting user features of the plurality of users into a classifier to obtain a predicted classification result, the predicted classification result indicating whether the plurality of users are users with a propensity to pay.

### RELATED APPLICATIONS

This application is a continuation of PCT Application No. PCT/CN2023/127252. Filed on Oct. 27, 2023, which claims priority to Chinese Patent Application No. 202211477548.6, entitled “METHOD AND APPARATUS FOR IDENTIFYING USER WITH PROPENSITY TO PAY, DEVICE, AND STORAGE MEDIUM” filed with the China National Intellectual Property Administration on Nov. 23, 2022, which are incorporated herein by reference in their entirety.

### FIELD OF THE TECHNOLOGY

This application relates to the field of artificial intelligence, and in particular, to user identification.

### BACKGROUND OF THE DISCLOSURE

An application program can provide various functions and services for a user. For example, a meeting software can facilitate, through audio and video, an online meeting for a plurality of users. To achieve accurate delivery of an advertisement in the application program. The application program needs to identify an user with a propensity to pay among users.

In a related art, identification is usually performed based on a preset rule. For example, if a user clicks on a membership advertisement more than five times in a week, it is considered that the user has a high propensity to pay.

However, a quantity of rules preset in the related art is limited, and parameters in each rule is usually determined based on manual experience. Consequently, accuracy of identifying the user with the propensity to pay in the related art is low.

### SUMMARY

This application provides an user identification method and apparatus, a device, and a storage medium, to improve accuracy of predicting whether a user of an application program has a propensity to pay. The technical solutions are as follows:

One aspect of the present disclosure provides an user identification method is provided. The method includes obtaining a plurality of users of an application program; generating, an account feature and a service feature of a user from the plurality of users, the account feature being based on account use information of the user in the application program, and the service feature being based on a historical payment-related behavior of the user; aggregating account features in a plurality of time dimensions to obtain a target account feature; aggregating service features in the plurality of time dimensions to obtain a target service feature; generating a user feature of the user based on the target account feature and the target service feature; and inputting user features of the plurality of users into a classifier to obtain a predicted classification result, the predicted classification result indicating whether the plurality of users are users with a propensity to pay.

Another aspect of the present disclosure provides a computer device. The computer device includes: a processor and a memory, the memory having a computer program stored therein, and the computer program being loaded and executed by the processor to implement the user identification method as described above.

Another aspect of the present disclosure provides a non-transitory computer-readable storage medium. The storage medium has a computer program stored therein, and the computer program is loaded and executed by a processor to implement the user identification method as described above.

The technical solutions according to embodiments of this application achieve at least the following practical improvements in identifying users with certain characteristics. In some embodiments, the account features and the service features in the plurality of time dimensions are aggregated, so that accuracy of predicting whether the user of the application program has the propensity to pay is improved. The plurality of time dimensions enrich manners of constructing the user feature and improve a coverage breadth of the user feature. In addition, aggregation reduces a feature dimension of sparse high-dimensional user feature space and improves an expression capability of the user feature. Therefore, aggregating the plurality of time dimensions can retain beneficial effects brought by the plurality of time dimensions. In addition, a dimensional disaster problem is avoided.

### BRIEF DESCRIPTION OF THE DRAWINGS

FIG. 1 is a schematic diagram of a computer system according to an embodiment of this application.

FIG. 2 is a schematic diagram of an user identification method according to an embodiment of this application.

FIG. 3 is a schematic diagram of a method for aggregating a plurality of time dimensions according to an embodiment of this application.

FIG. 4 is a flowchart of an user identification method according to another embodiment of this application.

FIG. 5 is a flowchart of an user identification method according to another embodiment of this application.

FIG. 6 is a flowchart of a method for screening to obtain a user of an application program according to an embodiment of this application.

FIG. 7 is a schematic diagram of a clustering algorithm for a noise reduction self-encoder according to an embodiment of this application.

FIG. 8 is a schematic diagram of a semi-supervised-based multi-view feature extraction algorithm according to an embodiment of this application.

FIG. 9 is a schematic diagram of beneficial effects according to an embodiment of this application.

FIG. 10 is a block diagram of a structure of an user identification apparatus according to an embodiment of this application.

FIG. 11 is a block diagram of a structure of a computer device according to an embodiment of this application.

### DESCRIPTION OF EMBODIMENTS

To make the objectives, technical solutions, and advantages of this application clearer, the following further describes implementations of this application in detail with reference to the accompanying drawings.

First, several terms involved in embodiments of this application are briefly introduced.

Multi view (Multi View): In some scenarios, a same item may be described from a plurality of different ways or different perspectives, and a plurality of descriptions constitute a plurality of views of the item. For example, for the same face, face images in a plurality of postures are obtained by capturing them from different perspectives. Similarly, a visible light image or a near-infrared image of the face may also be obtained through visible light or near-infrared illumination respectively, and these different images may be regarded as a plurality of views of the same face. However, the images from different views necessarily adhere to completely different space, and the images from different views cannot be directly compared with each other.

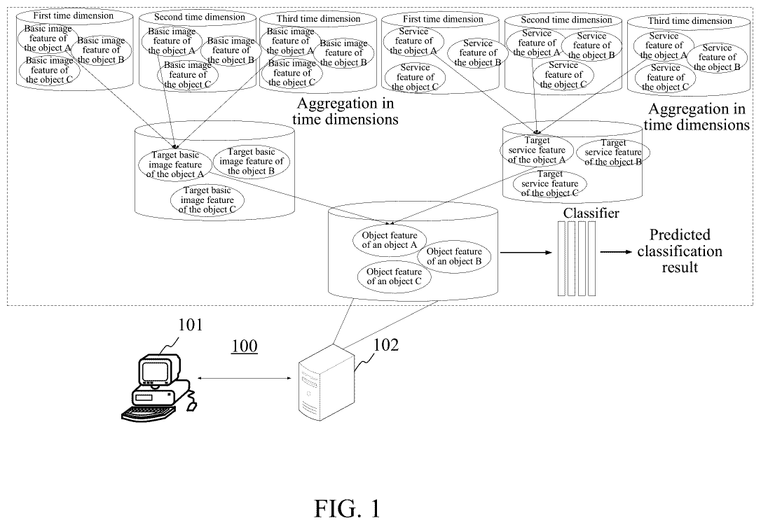

FIG. 1 is a schematic diagram of a computer system 100 according to an embodiment of this application. The computer system 100 includes a terminal 101 and a server 102.

In some embodiments, the terminal 101 performs the user identification method according to this application. An application program is installed on the terminal 101. The application program includes online meeting software, social interaction software, video player software, a game application program, or the like. The terminal 101 may be a smartphone, a tablet computer, a notebook computer, a desktop computer, a smart television, a wearable device, a vehicle-mounted terminal, a smart speaker, a smart watch, or the like, but is not limited thereto. In some embodiments, there may be one or more terminals 101. This is not limited in this application.

In some embodiments, the server 102 performs the user identification method according to this application. The server 102 is configured to support running of an application program, and the application program includes online meeting software, social interaction software, video player software, a game application program, or the like. The server 102 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

In some embodiments, the terminal 101 and the server 102 jointly perform the user identification method in a collaborative manner. The terminal 101 and the server 102 may be directly or indirectly connected in a wired or wireless communication manner. This is not limited in this application.

FIG. 1 further shows a procedure in which the server 102 constructs an user feature database. Based on an user feature obtained through construction, a probability that a user is an user with a propensity to pay is predicted by a classifier. It is assumed that users of the application program include an user A, an user B, and an user C, and there are three time dimensions in total.

An account feature and a service feature of the user A, an account feature and a service feature of the user B, and an account feature and a service feature of the user C in a first time dimension are obtained; an account feature and a service feature of the user A, an account feature and a service feature of the user B, and an account feature and a service feature of the user C in a second time dimension are obtained; and an account feature and a service feature of the user A, an account feature and a service feature of the user B, and an account feature and a service feature of the user C in a third time dimension are obtained.

The user A is used as an example for description in FIG. 1. Similarly, procedures of constructing user features of the user B and the user C may be obtained. For the account feature, the account feature of the user A in the first time dimension, the account feature of the user A in the second time dimension, and the account feature of the user A in the third time dimension are aggregated to obtain a target account feature of the user A. For the service feature, the service feature of the user A in the first time dimension, the service feature of the user A in the second time dimension, and the service feature of the user A in the third time dimension are aggregated to obtain a target service feature of the user A. An user feature of the user A is obtained based on the account feature of the user A and the service feature of the user A. The user feature of the user A, the user feature of the user B, and the user feature of the user C constitute a complete user feature database.

Then, the user feature in the user feature database is input into the classifier, and a predicted classification result is output by the classifier. The predicted classification result is configured for indicating whether the user is the user with the propensity to pay.

In an user identification method procedure shown in FIG. 1, the account features and the service features in a plurality of time dimensions are aggregated, so that accuracy of predicting whether the user of the application program has the propensity to pay is improved. The plurality of time dimensions enrich manners of constructing the user feature and improve a coverage breadth of the user feature. In addition, aggregation reduces a feature dimension of originally sparse high-dimensional user feature space and improves an expression capability of the user feature. Therefore, aggregating the plurality of time dimensions can retain beneficial effects brought by the plurality of time dimensions. In addition, a dimensional disaster problem is avoided.

In this application, a prompt interface or a pop-up window may be displayed or voice prompt information may be output before and during collection of related data of a user. The prompt interface, the pop-up window, or the voice prompt information is configured for prompting the user that the related data of the user is currently being collected, so that in this application, only after a confirmation operation performed by the user on the prompt interface or the pop-up window is obtained, a related operation of obtaining the related data of the user starts to be performed. Otherwise (to be specific, when a confirmation operation performed by the user on the prompt interface or the pop-up window is not obtained), a related operation of obtaining the related data of the user ends. That is, the related data of the user is not obtained. In other words, in this application, all the collected user data is collected with user consent and authorization, and collection, use, and processing of the related user data need to comply with related laws, regulations, and standards of related countries and regions.

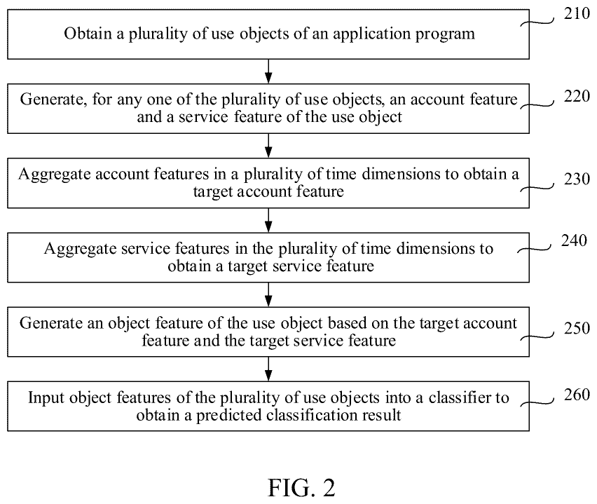

FIG. 2 is a flowchart of an user identification method according to an embodiment of this application. An example in which the method is performed by the server 102 shown in FIG. 1 is used for description. The method includes the following operations.

Operation 210: Obtain a plurality of users of an application program.

The application program refers to software provided with a charging function. The application program provides an additional service for a paying user. The application program includes online meeting software, social interaction software, video player software, a game application program, and the like. For example, the application program includes the online meeting software. The online meeting software refers to software that provides a function of performing, through audio and video, an online meeting for a plurality of people. In some embodiments, the online meeting software includes a standard edition and an enterprise edition. In some embodiments, the standard edition supports a smaller quantity of meeting participants than that of the enterprise edition. The standard edition supports lower video resolution than that of the enterprise edition. The enterprise edition supports a simultaneous interpretation function (which is not supported by the standard edition). Therefore, a service provider of the online meeting software sets the enterprise edition for a fee, and the standard edition for free. For the service provider of the online meeting software, a user with a propensity to pay for the online meeting software needs to be identified, to accurately deliver an advertisement to such users and save advertisement delivery resources.

In an embodiment, the user of the application program uses an account registered on the application program as an account used by the user. That is, one registered account corresponds to one user. In an embodiment, a server obtains accounts of a large quantity of users from an account database of the application program, and performs the following identification process based on information about the user. In an embodiment, the user of the application program may be a user who has paid previously, a user who has never paid, or a user who currently pays for an additional service.

Operation 220: Generate, for any one of the plurality of users, an account feature and a service feature of the user.

The account feature refers to a feature generated based on account use information of the user. In an embodiment, the account feature is a feature unrelated to a historical payment-related behavior of the user. The account use information of the user includes not only personal information of the user in the account, but also account information of the user, terminal information, and the like. For example, the account feature includes a gender, an age, and an industry of employment of the user, a company the user works for, duration of each running of the application program, a quantity of times the application program is run within a preset time range, interval duration during which the application program is run within the preset time range, a model of a terminal on which the application program is run, a version number of an operating system on which the application program is run, a network connection status (a network connection through Wi-Fi, 4G, or 5G) when the application program is run, a traffic consumption status (a time distribution status of generating traffic) when the application program is run, and the like.

The service feature refers to a feature generated based on the historical payment-related behavior of the user. In some embodiments, the service feature includes a historical click status of the user on a paid advertisement. For example, the service feature includes a historical click status of the user on a membership advertisement. The historical click status includes a quantity of clicks within the preset time range, click interval duration, and the like. In an embodiment, the service feature further includes duration of stay on a paid advertisement page. In an embodiment, the service feature further includes a conversion rate of the paid advertisement. For example, if the user clicks on the paid advertisement 10 times and activates a membership service 2 times, the conversion rate of the paid advertisement is 0.2.

Operation 220 to operation 250 are only an example in which a process of constructing the user feature of one user is performed. Similarly, a plurality of user features of the plurality of users may be obtained.

Operation 230: Aggregate the account features in a plurality of time dimensions to obtain a target account feature.

The plurality of time dimensions refer to different time spans in which the account feature and the service feature are aggregated. For example, the plurality of time dimensions include the last week, the last month, the last three months, the last half of a year, and the like. The quantity of time dimensions is not limited in this application. In an embodiment, features in the plurality of time dimensions are aggregated by using summation, median, standard deviation, or the like.

For example, the account feature includes a quantity of times the application program is run. In the last week, the application program is run 5 times by the user. In the last month, the application program is run 10 times by the user. In the last three months, the application program is run 13 times by the user. In the last half year, the application program is run 16 times by the user. Four time dimensions are aggregated by using the summation, and the generated feature value of “a quantity of times the application program is run” is 44.

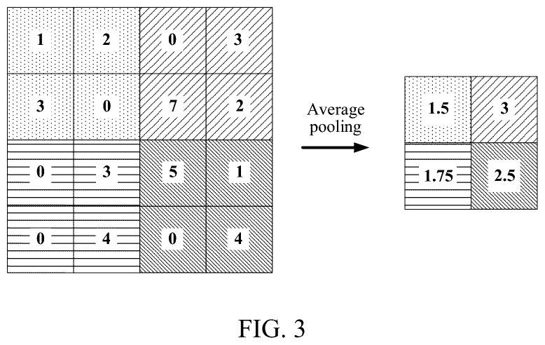

For example, FIG. 3 is a schematic diagram of a feature aggregating a plurality of time dimensions. Feature values in the four time dimensions are 1, 2, 3, and 0, and a value obtained by performing average pooling on the feature values is 1.5; feature values in the four time dimensions are 0, 3, 7, and 2, and a value obtained by performing average pooling on the feature values is performed is 3; feature values in the four time dimensions are 0, 3, 0, and 4, and a value obtained by performing average pooling on the feature values is performed is 1.75; and feature values in the four time dimensions are 5, 1, 0, and 4, and a value obtained by performing average pooling on the feature values is 2.5.

Operation 240: Aggregate service features in the plurality of time dimensions to obtain a target service feature.

For example, the service feature includes the interval duration for clicking on the paid advertisement. Maximum interval duration for the user to click on the paid advertisement in the last week is 2 days. Maximum interval duration for the user to click on the paid advertisement in the last month is 10 days. Maximum interval duration for the user to click on the paid advertisement in the last three months is 10 days. Maximum interval duration for the user to click on the paid advertisement in the last half of a year is 25 days. Four time dimensions are aggregated by using the median, and a generated feature value of “the interval duration for clicking on the paid advertisement” is 10.

Operation 250: Generate an user feature of the user based on the target account feature and the target service feature.

In an embodiment, the target account feature and the target service feature are concatenated to obtain the user feature of the user. Operation 220 to operation 250 constitute an operation of generating the user feature of one user. Similarly, user features of the plurality of users may be obtained through construction.

Operation 260: Input the user features of the plurality of users into a classifier to obtain a predicted classification result.

The predicted classification result is configured for indicating whether the plurality of users are users with a propensity to pay.

In an embodiment, the classifier is in a fully supervised manner. To be specific, the classifier is trained by using all user features and all payment labels in a training sample set. A payment label is configured for indicating whether a training sample has the propensity to pay. A payment label of a training sample currently in (for a fee) a membership service is set to 1, and a payment label of a training sample not currently in (for a fee) the membership service is set to −1.

In another embodiment, the classifier is trained in a semi-supervised manner. Because data of the training sample set is excessively large, it is often impossible to assign a payment label to each training sample. Under semi-supervision, payment labels are assigned to a small part of training samples, and a large part of the training samples are unlabeled.

In an embodiment, the classifier clusters the plurality of users based on the user features, and clusters closer user features in the plurality of user features into a same class cluster. The classifier clusters the plurality of users into at least two classes, that is, obtains the predicted classification result. The predicted classification result is to distinguish among a user with a high propensity to pay, a user with a medium propensity to pay, and a user with a low propensity to pay.

In an embodiment, the classifier first processes the user features of the users based on the multi-view feature extraction algorithm, and then classifies the user features based on a plurality of processed features respectively corresponding to the plurality of users.

Multi view may be understood as describing a same item from a plurality of different ways or different perspectives, and a plurality of descriptions constitute a plurality of views of the item. In this application, in some embodiments, the account feature in the user feature constitutes a view, the service feature constitutes a view, the account information of the user in the account feature constitutes a view, and a quantity of clicks on the paid advertisement in the service feature constitutes a view. This application does not limit a specific multi-view constitution manner and a quantity of views. In this application, because the user feature has a high-dimensional and sparse characteristic, utilization of the user feature may be improved based on the multi-view feature extraction algorithm. In this application, a semi-supervised-based multi-view feature extraction algorithm is further described. The semi-supervised manner improves training efficiency of the classifier, and is also more applicable to a case in which a quantity of training sample datasets is huge.

In conclusion, the account features and the service features in the plurality of time dimensions are aggregated, so that accuracy of predicting whether the user of the application program has the propensity to pay is improved. The plurality of time dimensions enrich manners of constructing the user feature and improve a coverage breadth of the user feature. In addition, aggregation reduces a feature dimension of originally sparse high-dimensional user feature space and improves an expression capability of the user feature. Therefore, aggregating the plurality of time dimensions can retain beneficial effects brought by the plurality of time dimensions. In addition, a dimensional disaster problem is avoided.

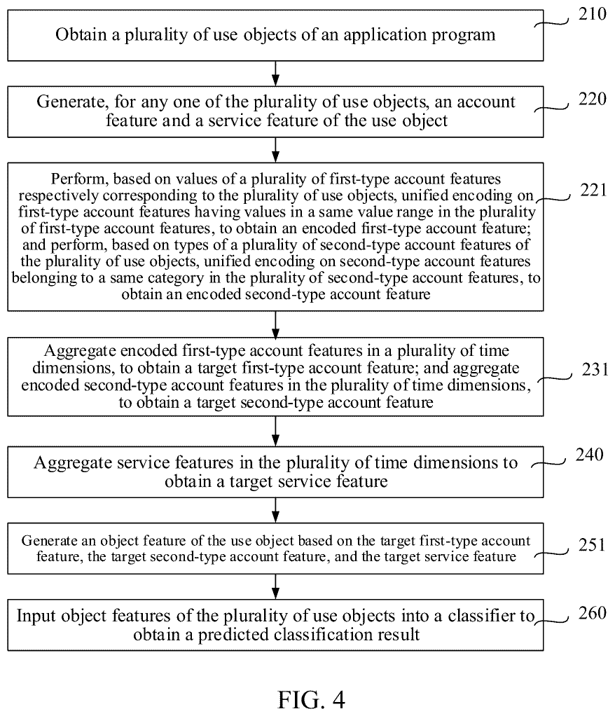

Based on the embodiment shown in FIG. 2, FIG. 4 is a flowchart of an user identification method according to an embodiment of this application. FIG. 2 further includes operation 221 after operation 220. In this case, operation 230 may be replaced with operation 231, and operation 250 may be replaced with operation 251.

Operation 221: Perform, based on values of a plurality of first-type account features respectively corresponding to the plurality of users, unified encoding on first-type account features having values in a same value range in the plurality of first-type account features, to obtain an encoded first-type account feature; and perform, based on types of a plurality of second-type account features of the plurality of users, unified encoding on second-type account features belonging to a same category in the plurality of second-type account features, to obtain an encoded second-type account feature.

In an embodiment, the account feature includes a first-type account feature and a second-type account feature. The first-type account feature refers to an account feature of the user including a value. For example, the version number of the operating system on which the application program is run is version 4.2, version 4.5, or version 4.7. In this embodiment, the first-type account features are uniformly encoded in a manner of consolidation encoding. For example, version numbers 4.2, 4.5, and 4.7 of the operating system are considered as low versions, and “0” is configured for unified encoding.

The second-type account feature refers to an account feature of the user including a type. For example, a gender of the user is male or female. In this embodiment, the second-type account features are uniformly encoded in a manner of one-hot encoding. For example, a gender male is encoded as (1, 0), and a gender female is encoded as (0, 1).

Operation 231: Aggregate encoded first-type account features in the plurality of time dimensions, to obtain a target first-type account feature; and aggregate encoded second-type account features in the plurality of time dimensions, to obtain a target second-type account feature.

In an embodiment, the encoded first-type account features are aggregated in the plurality of time dimensions to obtain the target first-type account feature; and the encoded second-type account features are aggregated in the plurality of time dimensions, to obtain the target second-type account feature.

Operation 251: Generate the user feature of the user based on the target first-type account feature, the target second-type account feature, and the target service feature.

In an embodiment, the target first-type account feature, the target second-type account feature, and the target service feature are concatenated to obtain the user feature of the user.

In conclusion, different encoding manners are configured for encoding the first-type account feature and the second-type account feature, so that a dimension of the finally constructed user feature can be effectively reduced, and utilization of original information can be improved.

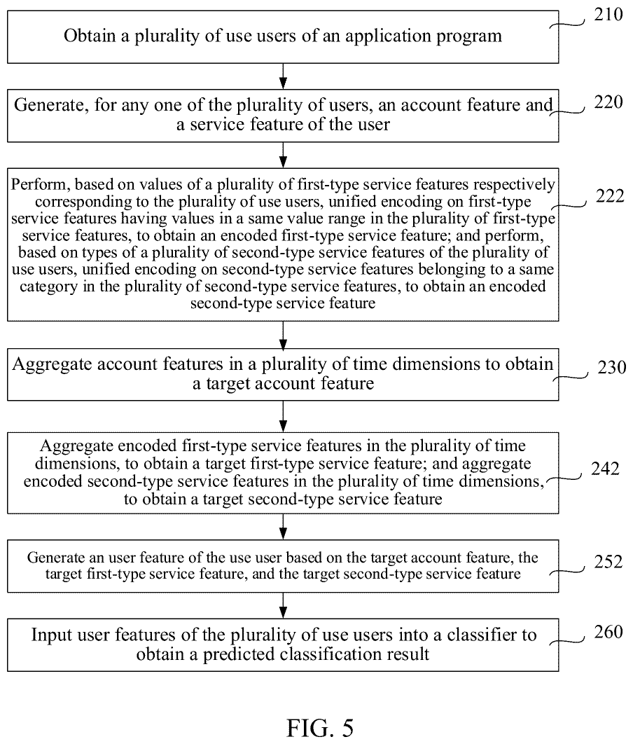

Based on the embodiment shown in FIG. 2, FIG. 5 is a flowchart of an user identification method according to an embodiment of this application. FIG. 2 further includes operation 222 after operation 220. In this case, operation 240 may be replaced with operation 242, and operation 250 may be replaced with operation 252.

Operation 222: Perform, based on values of a plurality of first-type service features respectively corresponding to the plurality of users, unified encoding on first-type service features having values in a same value range in the plurality of first-type service features, to obtain an encoded first-type service feature; and perform, based on types of a plurality of second-type service features of the plurality of users, unified encoding on second-type service features belonging to a same category in the plurality of second-type service features, to obtain an encoded second-type service feature.

In an embodiment, the service feature includes a first-type service feature and a second-type service feature. The first-type service feature refers to a service feature of the user including a value. For example, the interval duration for the user to click on the paid advertisement is 5 h, 10.3 h, or 25.6 h. In this embodiment, the first-type service features are uniformly encoded in a manner of consolidation encoding. For example, a feature with interval duration of clicking on the paid advertisement of less than 3 days is considered as frequently clicking, and “1” is configured for unified encoding.

The second-type service feature refers to a service feature of the user including a category. For example, the user has paid and has never paid. In this embodiment, the second-type service features are uniformly encoded in a manner of one-hot encoding. For example, having paid is encoded as (1, 0), and having never paid is encoded as (0, 1).

Operation 242: Aggregate encoded first-type service features in the plurality of time dimensions, to obtain a target first-type service feature; and aggregate encoded second-type service features in the plurality of time dimensions, to obtain a target second-type service feature.

In an embodiment, the encoded first-type service features are aggregated in the plurality of time dimensions to obtain the target first-type service feature; and the encoded second-type service features are aggregated in the plurality of time dimensions, to obtain the target second-type service feature.

Operation 252: Generate the user feature of the user based on the target account feature, the target first-type service feature, and the target second-type service feature.

In an embodiment, the target account feature, the target first-type service feature, and the target second-type service feature are concatenated to obtain the user feature of the user.

In conclusion, different encoding manners are configured for encoding the first-type service feature and the second-type service feature, so that a dimension of the finally constructed user feature can be effectively reduced, and utilization of original information can be improved.

The user identification methods shown in FIG. 4 and FIG. 5 may be alternatively used, or may be used in combination. This is not limited in this application.

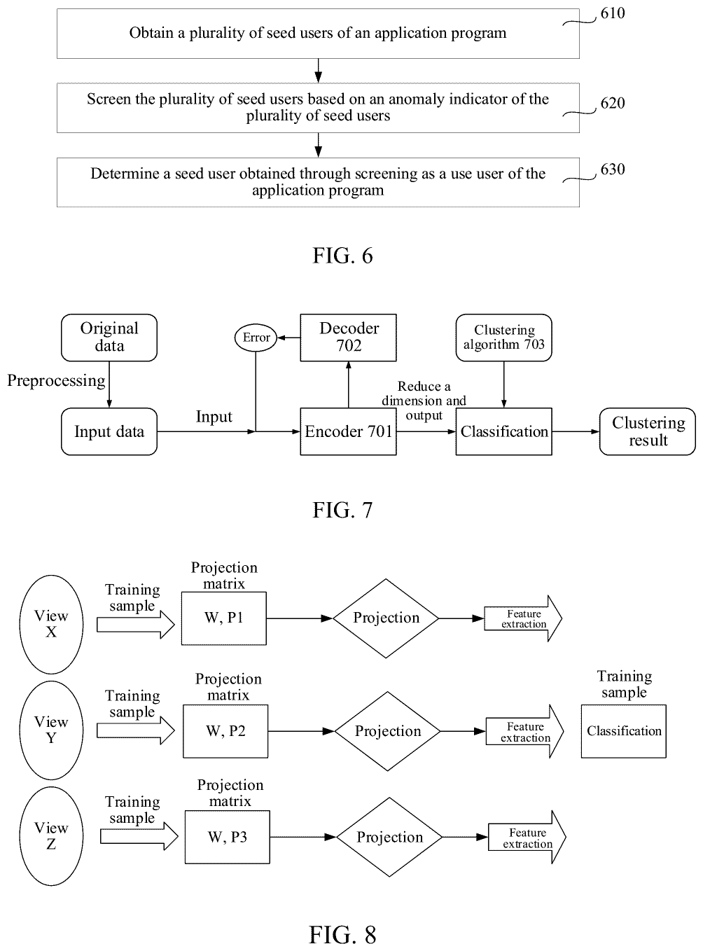

In an embodiment, based on the embodiment shown in FIG. 2, an operation of obtaining the user of the application program through screening is further included. FIG. 6 is a flowchart of an user identification method according to an embodiment of this application. Before operation 210 in FIG. 2, the following operation 610 to operation 630 are further included.

Operation 610: Obtain a plurality of seed users of the application program.

The seed user refers to an user configured for performing a subsequent screening operation.

In an embodiment, after a large quantity of users are recalled based on a coarse rule, filtering is performed through manual screening, and then verification is performed based on service logic, and an user that passes the verification is determined as the seed user. The manual screening refers to manually performing screening in a coarse manner. For example, the application program is meeting software of an enterprise edition, and a quantity of employees in an enterprise obtained through the manually screening exceeds an user threshold. The service logic verification refers to setting a rule of the manual screening based on the service logic. For example, if the application program is the meeting software of the enterprise edition, the service logic verification is to verify, based on an algorithm, that an user that has been manually screened is a worker aged 20 to 55 years old.

Operation 620: Screen the plurality of seed users based on an anomaly indicator of the plurality of seed users.

The anomaly indicator refers to an indicator configured for determining whether the seed user is anomalous. In the real world, there may be an user that abnormally uses the application program, for example, a large quantity of application programs controlled and run by a hacker by using a zombie computer, an user that uses an application program after the application program is cracked maliciously, and the like. In this embodiment, the plurality of seed users are screened based on the anomaly indicator, to obtain a real user of the application program.

An example in which the application program is the online meeting software is used for description below.

In an embodiment, the anomaly indicator includes duration for which the seed user uses the online meeting software within a first duration range. For example, the plurality of seed users are grouped to obtain a plurality of groups. Variance determination is performed on any one of the plurality of groups to screen the plurality of seed users. The variance determination includes: obtaining, for one seed user in an i^{th} group of the plurality of groups, the duration for which the seed user uses the online meeting software within the first duration range; calculating a variance of use duration of all seed users in the i^{th} group, the i^{th} group being any one of the plurality of groups; and removing all the seed users in the i^{th} group when the variance is greater than a first variance value; or retaining all the seed users in the i^{th} group when the variance is not greater than a first variance value.

In an embodiment, the anomaly indicator includes a quantity of times that the seed user participates in an online meeting through the online meeting software within a second duration range. For example, the plurality of seed users are grouped to obtain a plurality of groups. Variance determination is performed on any one of the plurality of groups to screen the plurality of seed users. The variance determination includes: obtaining, for one seed user in an i^{th} group of the plurality of groups, the quantity of times that the seed user participates in the online meeting through the online meeting software within the second duration range; calculating a variance of times of participation of all seed users in the i^{th} group, the i^{th} group being any one of the plurality of groups; and removing all the seed users in the i^{th} group when the variance is greater than a second variance value; or retaining all the seed users in the i^{th} group when the variance is not greater than a second variance value.

In an embodiment, the anomaly indicator includes a duration distribution status of participating in an online meeting through the online meeting software within a third duration range. For example, the plurality of seed users are grouped to obtain a plurality of groups. Variance determination is performed on any one of the plurality of groups to screen the plurality of seed users. The variance determination includes: obtaining, for one seed user in an i^{th} group of the plurality of groups, a duration distribution status in which the seed user participates in the online meeting through the online meeting software within the third duration range, the duration distribution status indicating duration for which the seed user participates in a meeting each time and a total quantity of times of participation; calculating a duration variance of duration for which all seed users in the i^{th} group participate in the meeting each time; calculating a times variance of the total quantity of times of participation of all the seed users in the i^{th} group; and removing all the seed users in the i^{th} group when the duration variance is greater than a third variance value and the times variance is greater than a fourth variance value; or retaining all the seed users in the i^{th} group when the duration variance is not greater than a third variance value or the times variance is not greater than a fourth variance value.

Operation 630: Determine a seed user obtained through screening as the user of the application program.

The seed users are screened based on the anomaly indicator, and the seed user obtained through the screening is determined as the user of the application program.

In conclusion, the seed user is obtained through screening and recalling based on the anomaly indicator, and an user that uses the application program abnormally in the real world is eliminated, for example, an user that controls and runs a large quantity of application programs, an user that uses an application program after the application program is cracked maliciously, and the like. A real user that participates in the user identification method according to this application is screened. This ensures accuracy and realness of a identification result.

The following describes a method for classifying the plurality of users based on the user features of the plurality of users. That is, a working principle of the classifier. In this application, the following first to third classifiers are provided.

First classifier: Based on the embodiment shown in FIG. 2, operation 260 may be replaced with the following operations 261-1 to 261-4. In this embodiment, the plurality of user features are used as test samples, and the following test process in the following multi-view feature extraction algorithm under semi-supervision is performed.

261-1: Generate, based on the plurality of user features, view features of the plurality of users in m views.

Multi view may be understood as describing a same item from a plurality of different ways or different perspectives, and a plurality of descriptions constitute a plurality of views of the item. In this application, in some embodiments, the account feature in the user feature constitutes a view, the service feature constitutes a view, the account information of the user in the account feature constitutes a view, and a quantity of clicks on the paid advertisement in the service feature constitutes a view. This application does not limit a specific multi-view constitution manner and a quantity of views.

In this embodiment, a connection between the plurality of views and a feature in the plurality of views will be considered. Based on the plurality of user features, the view features of the plurality of users in the m views are generated. m view features respectively corresponding to the m views are to be generated for an user feature of each user.

261-2: Generate, for a t^{th} view of the m views, a t^{th} predicted payment label matrix based on a plurality of view features respectively corresponding to the plurality of users in the t^{th} view in combination with a t^{th} projection matrix obtained through pre-training.

The t^{th} predicted payment label matrix refers to a matrix indicating whether the plurality of users obtained through identification have a propensity to pay in the t^{th} view. The predicted payment label is configured for indicating whether a user obtained through the identification has the propensity to pay. A payment label of a user obtained through the identification that has the propensity to pay is set to 1, and a payment label of a user obtained through the identification that does not have the propensity to pay is set to −1.

For the t^{th} view, the t^{th} view and another view are aligned to same projection space by using the t^{th} projection matrix, and the another view includes a view other than the t^{th} view of the m views. The t^{th} projection matrix corresponds to view features of all users in the t^{th} view.

In an embodiment, the t^{th} projection matrix includes a t^{th} sample projection matrix and a label projection matrix W. The t^{th} sample projection matrix is configured for aligning a view feature in the t^{th} view to sample projection space. The label projection matrix W is configured for aligning a predicted payment label corresponding to the view feature in the t^{th} view to label projection space. In some embodiments, the label projection matrix W is common to the m views.

A manner of generating the t^{th} projection matrix is introduced below in a “training process” in the multi-view feature extraction algorithm under the semi-supervision. The t^{th} projection matrix is obtained by concatenating the t^{th} sample projection matrix and the label projection matrix W in the t^{th} view. A manner of generating the t^{th} predicted payment label matrix is introduced below in the “test process” in the multi-view feature extraction algorithm under the semi-supervision.

261-3: Calculate the mean of m predicted payment label matrices in the m views.

According to the foregoing descriptions of the t^{th} projection matrix, the m predicted payment label matrices in the m views are obtained. Then, the m predicted payment label matrices are averaged.

261-4: Determine the mean as the predicted classification result.

The mean value is determined as the predicted classification result.

Actually, the foregoing operation 261-1 to operation 261-4 constitute the “test process” in the following multi-view feature extraction algorithm under the semi-supervision. For details, refer to the following descriptions.

In conclusion, the first classifier uses the multi-view feature extraction algorithm under the semi-supervision, to take into account information of interaction between and within the plurality of views, so that the multi-view feature extraction algorithm can improve utilization of original feature information.

Second classifier: Based on the embodiment shown in FIG. 2, operation 260 may be replaced with the following operations 262-1 to 262-4.

262-1: Input, for one of the plurality of user features, the user feature into an encoder, to obtain a low-dimensional user feature; input the low-dimensional user feature into a decoder, to obtain a high-dimensional user feature; and calculate an error between the user feature and the high-dimensional user feature.

In an embodiment, before the user feature is input into the encoder, preprocessing performed on the user feature, such as data cleaning, is further performed. Referring to FIG. 7, FIG. 7 shows that original data (user feature) is preprocessed to obtain input data (preprocessed user feature). Then, the input data is input into an encoder 701 to obtain the low-dimensional user feature, and the low-dimensional user feature is input into a decoder 702 to obtain the high-dimensional user feature. An error between the high-dimensional user feature and the input data (the preprocessed user feature) is calculated.

262-2: Adjust the encoder and the decoder based on the error when the error does not reach a convergence condition; determine the high-dimensional user feature as the user feature; re-perform inputting the user feature into the encoder, to obtain a low-dimensional user feature; input the low-dimensional user feature into the decoder, to obtain a high-dimensional user feature; and calculate an error between the user feature and the high-dimensional user feature.

Referring to FIG. 7, when the error obtained through calculation does not reach a convergence condition, the encoder 701 and the decoder 702 are adjusted based on the error. The high-dimensional user feature is used as a new user feature, and the user feature is input into the encoder 701 to obtain a low-dimensional user feature. Then, the low-dimensional user feature is input into the decoder 702, to obtain a high-dimensional user feature. An error between the user feature and the high-dimensional user feature is calculated.

262-3: Output the low-dimensional user feature when the error reaches a convergence condition.

Referring to FIG. 7, when the error reaches the convergence condition, the encoder 701 reduces a dimension and performs output, and outputs the low-dimensional user feature.

262-4: Cluster the plurality of users based on a plurality of low-dimensional user features corresponding to the plurality of user features, to obtain the predicted classification result.

Referring to FIG. 7, the plurality of low-dimensional user features corresponding to the plurality of user features are classified based on a clustering algorithm 703 to obtain a clustering result. The clustering result is configured for determining whether the plurality of users have the propensity to pay. In some embodiments, the clustering algorithm is a K-means clustering algorithm.

In conclusion, the second classifier uses a noise reduction self-encoder clustering algorithm, to highlight an important feature representation in the user features. In addition, the dimension-reduced user feature is clustered by using the clustering algorithm. This effectively improves an ability to handle a problem with a large quantity of dimensions and enhances algorithm efficiency, and resolves problems, such as susceptibility to local optima, computational complexity and inefficiency, and significant impact of an irrelevant feature, caused by a sparse high-dimensional dataset.

Third classifier: Based on the embodiment shown in FIG. 2, operation 260 may be replaced with the following operations 263-1 to 263-7.

263-1: Generate, based on the plurality of user features, view features of the plurality of users in m views.

Multi view may be understood as describing a same item from a plurality of different ways or different perspectives, and a plurality of descriptions constitute a plurality of views of the item. In this application, in some embodiments, the account feature in the user feature constitutes a view, the service feature constitutes a view, the account information of the user in the account feature constitutes a view, and a quantity of clicks on the paid advertisement in the service feature constitutes a view. This application does not limit a specific multi-view constitution manner and a quantity of views.

In this embodiment, a connection between the plurality of views and a feature in the plurality of views will be considered. Based on the plurality of user features, the view features of the plurality of users in the m views are generated. m view features respectively corresponding to the m views are to be generated for an user feature of each user.

263-2: Obtain, through training for a t^{th} view of the m views, a t^{th} projection matrix based on a plurality of view features respectively corresponding to the plurality of users in the t^{th} view and payment labels of some of the plurality of users.

For the t^{th} view, the t^{th} view and another view are aligned to same projection space by using the t^{th} projection matrix, and the another view includes a view other than the t^{th} view of the m views. The t^{th} projection matrix corresponds to view features of all users in the t^{th} view.

In an embodiment, the t^{th} projection matrix includes a t^{th} sample projection matrix and a label projection matrix W. The t^{th} sample projection matrix is configured for aligning a view feature in the t^{th} view to sample projection space. The label projection matrix W is configured for aligning a predicted payment label corresponding to the view feature in the t^{th} view to label projection space. In some embodiments, the label projection matrix W is common to the m views. The t^{th} projection matrix is obtained by concatenating the t^{th} sample projection matrix and the label projection matrix W in the t^{th} view.

In this embodiment, the plurality of user features are used as training samples, and the training process in the following multi-view feature extraction algorithm under the semi-supervision is performed, to obtain projection matrices corresponding to the views. A manner of generating the projection matrices corresponding to the views is introduced below in the “training process” in the multi-view feature extraction algorithm under the semi-supervision.

263-3: Generate a target projection matrix based on m projection matrices corresponding to the m views, the target projection matrix being configured for indicating a plurality of target user features respectively corresponding to the plurality of users.

In an embodiment, the target projection matrix is generated by concatenating (Concat) the projection matrices. The target projection matrix may be understood not only as including features in a plurality of view dimensions, but also as including features in a plurality of user dimensions. That is, the target projection matrix is configured for indicating the plurality of target user features respectively corresponding to the plurality of users.

263-4: Input, for one of the plurality of target user features, the target user feature into an encoder, to obtain a low-dimensional target user feature; input the low-dimensional target user feature into a decoder, to obtain a high-dimensional target user feature; and calculate an error between the target user feature and the high-dimensional target user feature.

In an embodiment, before the target user feature is input into the encoder, preprocessing performed on the target user feature, such as data cleaning, is further performed. Referring to FIG. 7, FIG. 7 shows that original data (target user feature) is preprocessed to obtain input data (preprocessed target user feature). Then, the input data is input into an encoder 701 to obtain the low-dimensional target user feature, and the low-dimensional target user feature is input into a decoder 702 to obtain the high-dimensional target user feature. An error between the high-dimensional target user feature and the input data (the preprocessed target user feature) is calculated.

263-5: Adjust the encoder and the decoder based on the error when the error does not reach a convergence condition; determine the high-dimensional user feature as the target user feature; re-perform inputting the target user feature into the encoder, to obtain a low-dimensional target user feature; input the low-dimensional target user feature into the decoder, to obtain a high-dimensional target user feature; and calculate an error between the target user feature and the high-dimensional target user feature.

Referring to FIG. 7, when the error obtained through calculation does not reach a convergence condition, the encoder 701 and the decoder 702 are adjusted based on the error. The high-dimensional target user feature is used as a new target user feature, and the target user feature is input into the encoder 701 to obtain a low-dimensional target user feature. Then, the low-dimensional target user feature is input into the decoder 702, to obtain a high-dimensional target user feature. An error between the target user feature and the high-dimensional target user feature is calculated.

263-6: Output the low-dimensional target user feature when the error reaches a convergence condition.

Referring to FIG. 7, when the error reaches the convergence condition, the encoder 701 reduces a dimension and performs output, and outputs the low-dimensional target user feature.

263-7: Cluster the plurality of users based on a plurality of low-dimensional target user features corresponding to the plurality of target user features, to obtain the predicted classification result.

Referring to FIG. 7, the plurality of low-dimensional target user features corresponding to the plurality of target user features are classified based on the clustering algorithm 703 to obtain a clustering result. The clustering result is configured for determining whether the plurality of users have the propensity to pay. In some embodiments, the clustering algorithm is a K-means clustering algorithm.

In conclusion, the third classifier intelligently combines an algorithm 1 (the multi-view feature extraction algorithm under the semi-supervision) and an algorithm 2 (the noise reduction self-encoder clustering algorithm), and the target projection matrix in the algorithm 1 is used as a link between the two algorithms, to jointly complete an identification task. Beneficial effects of the algorithm 1 (considering the information of the interaction between and within the plurality of views, so that the multi-view feature extraction algorithm can improve the utilization of the original feature information) are obtained. In addition, beneficial effects of the algorithm 2 (highlighting the important feature representation in the user features) are obtained. In addition, the dimension-reduced user feature is clustered by using the clustering algorithm. This effectively improves the ability to handle the problem with the large quantity of dimensions and enhances the algorithm efficiency, and resolves the problems, such as the susceptibility to the local optima, the computational complexity and inefficiency, and the significant impact of the irrelevant feature, caused by the sparse high-dimensional dataset.

The following describes the multi-view feature extraction algorithm under the semi-supervision.

An overall idea is shown in FIG. 8. In the multi-view feature extraction algorithm under the semi-supervision, in a training phase, projection matrices corresponding to views (a view X, a view Y, and a view Z) are first obtained. In a test phase, projection operations are performed on view features of a test sample by using the projection matrices, to extract the view features. Test samples are classified based on the view features.

To facilitate detailed descriptions of the algorithm, algorithm symbols are first described.

A training sample set is constructed based on a plurality of samples, and corresponds to m views, and each view corresponds to n samples. Xₜ=[x₁^{(t)}, x₂^{(t)}, . . . , xₗ^{(t)}, xₗ₊₁^{(t)}, . . . , xₙ^{(t)}] represents a sample in a t^{th} view of the samples, xᵢ⁽ⁱ⁾∈R^{d}^{ₜ}^{×1} (1≤i≤n) being a feature of an i^{th} sample corresponding to the t^{th} view. dₜ represents a dimension of feature space in the t^{th} view. It is assumed that in Xₜ, a first l samples are labeled, while a remaining n−l samples are unlabeled. Next, a mark matrix of a training dataset corresponding to the t^{th} view is given as Yₜ, and Yₜ=[y₁^{(t)}, y₂^{(t)}, . . . , yₗ^{(t)}, yₗ₊₁^{(t)}, . . . , yₙ^{(t)}]^{T}∈{−1, 0, 1}^{n×c}, c being a quantity of labels, and in addition, when 1≤i≤l (in other words, there is a labeled sample), a label matrix is yᵢ^{(t)}∈{−1, 1}^{c}. When l+1≤i≤n (in other words, there is no labeled sample), a label matrix, yᵢ^{(t)} an all-zero matrix. Next, yᵢⱼ^{(t)} represents i^{th} sample data corresponding to a j^{th} category and a t^{th} view. If an i^{th} sample corresponds to the j^{th} category, the sample data is correctly divided into a category to which the sample data belongs, that is, yᵢⱼ^{(t)}=1; otherwise, yᵢⱼ^{(t)}=−1. In other words, the (t) i^{th} sample does not belong to the j^{th} category. In addition, when the sample is unlabeled, yᵢⱼ^{(t)} is set to 0. An objective of this work is to fully utilize both the labeled sample and the unlabeled sample in a plurality of views, to learn from a robust classifier for image recognition. To fully utilize all sample data, it is defined that F=[f₁, f₂, . . . , fₙ]^{T}∈R^{n×c}, and F is used as a label matrix for predicting all training data, fᵢ∈R^{c} (1≤i≤n) being a predicted label of the i^{th} sample.

### Training Process:

Objective function construction: Sample projection matrices Pₜ in various views, a label projection matrix W, and a bias term b are constructed and obtained by obtaining a minimum value of an objective function. During testing, an identification label matrix of the test sample can be obtained based on the view features of the test sample by combining the sample projection matrix Pₜ, the label projection matrix W, and the bias term b. The objective function is as follows in Formula (1).

$${min}_{\{ {F}_{t} , {P}_{t} , W , b \} {\vert}_{t = 1}^{m}} {\sum }_{t = 1}^{m} ( \begin{matrix}Tr ( {F}_{t}^{T} {L}_{t} {F}_{t} ) + Tr ( {( {F}_{t} - {Y}_{t} )}^{T} U ( {F}_{t} - {Y}_{t} ) ) + \\ μ {‖ {( {P}_{t}^{T} {X}_{t} )}^{T} W + {1}_{n} {b}^{T} - {F}_{t} ‖}_{2 , 1}\end{matrix} ) + {‖ W ‖}_{F}^{2} ; \qquad ( 1 )$$

Formula (1) benefits from multi-view learning and graph-based semi-supervised learning and combines two learning methods. Formula (1) is applied to a calculation process of obtaining the multi-view semi-supervised learning algorithm. The algorithm may be configured for resolving a problem of multi-view semi-supervision in a classification method. Then, the view-dependent identification label matrix Fₜ may be calculated by using Formula (1).

A first part of the objective function Tr(Fₜ^{T}LₜFₜ) is local preservation for a graph-based semi-supervised learning method. Fₜ is to satisfy smoothness of a basic real label in training data and a graphical model S at the same time, and Laplacian matrices of the views are defined as follows.

For data Xₜ=[X₁, X₂, X₃ . . . Xₙ] of the t^{th} view, a view-based Laplacian matrix Lₜ is calculated based on a view feature Xₜ. A set of sample data is given, and an image model S is defined. An element Sᵢⱼ of the image model S reflects a similarity between an i^{th} sample and a j^{th} sample. A simple definition of S is as follows:

$${S}_{ij} = \{ \begin{matrix}1 , {x}_{i} ∈ {N}_{k} ( {x}_{j} ) or {x}_{j} ∈ {N}_{k} ( {x}_{i} ) \\ 0 , otherwise\end{matrix} ; \qquad ( 2 )$$

In Formula (2), Nₖ(·) represents k nearest neighbor data sets of data. Based on a definition of a diagonal matrix D, in D, an i^{th} diagonal element of D is calculated as Dᵢᵢ=Σᵢ₌₁ⁿSᵢⱼ. A Laplacian matrix is calculated as follows:

$$L = D - S ; \qquad ( 3 )$$

In the graph-based semi-supervised learning method, a second part of the objective function Tr((Fₜ−Yₜ)^{T}U(Fₜ−Yₜ)) enables the identification label matrix Fₜ to satisfy the smoothness of the basic real label in the training data and the graphical model S at the same time. Therefore, a predicted label may be obtained by comparing the predicted label and a real label difference and minimizing the predicted label. A purpose is to make a predicted mark and a real mark of each view relatively consistent after learning. U∈R^{n×n} is a diagonal matrix, and is referred to as a decision rule matrix. A diagonal element Uᵢᵢ of the matrix is determined depending on whether an i^{th} data point is marked. If the i^{th} data point is marked, Uᵢᵢ is a large number; otherwise, Uᵢᵢ=1. The decision rule matrix U makes a predicted label F consistent with a basic real label matrix Y.

For a third part μ∥(Pₜ^{T}Xₜ)^{T}W+1ₙb^{T}−Fₜ∥_{2,1} of the objective function to learn from a robust classifier, the classifier is to be able to tolerate a sample with a noise label. Herein, adaptive power at different noise levels is integrated for a robust loss function. For this reason, a broad sense l_{2,1} loss is adopted, and a frame may be added to the part. μ is an equilibrium parameter, W∈R^{d×c} is a label projection matrix common to a plurality of views, b∈R^{c} is a bias term common to the plurality of views, ∥W∥_{F}² is a regularization term, and 1ₙ is an all-ones vector. A l_{2,1} norm of a matrix M is defined as: ∥M∥_{2,1}=Σᵢ₌₁ⁿ∥Mᵢ∥₂, Mᵢ being an i^{th} row of M. Next, projection processing is performed on a sample in this part. Projection performed on each view sample is applied to multi-view. First, Pₜ of this part is used as a sample projection matrix. In this term μ∥(Pₜ^{T}Xₜ)^{T}W+1ₙb^{T}−Fₜ∥_{2,1}, Pₜ^{T}Xₜ may perform dimension reduction and denoising on the sample Xₜ after performing projection on the sample by using the Pₜ matrix, and then a label projection matrix W and a bias term b for denoising are shared for each view. Therefore, while learning an effective classifier, dimension reduction and denoising can be performed on a sample Xₜ of each view by using Pₜ projection. In addition, the common label projection matrix W and the common bias term b can effectively learn sample features of the plurality of views, and is conducive to learning a robust classifier. For a test sample of each view, in a classification process, there is no need to separately learn the label projection matrix and the bias term for each view, and classification through a classifier formed by a common matrix is more convenient.

The last part γ∥W∥_{F}² of the objective function is to add a regularization term. This term is placed outside the parentheses, because γ∥W∥_{F}² of the last term is independent of a specific view. The term may be placed outside a previous summation formula of a specific view as a regularization term of a common label projection matrix for all views. Using the term for label projection can achieve a purpose of extracting complementary information of all the views, so that complexity of the label projection matrix W is the least, γ being a balance parameter.

Construction content of the objective function has been introduced above. The following describes a method to solve the foregoing objective function, that is Formula (1), through an iterative algorithm.

Due to l_{2,1} loss and non-convexity of a l_{2,1} regularization matrix in Formula (1), an analytical solution of Formula (1) cannot be directly obtained. To overcome this problem, Formula (1) is transformed into the following alternative Formula (4) first:

$${min}_{\{ {F}_{t} , {P}_{t} , W , b \} {\vert}_{t = 1}^{m}} {\sum }_{t = 1}^{m} ( \begin{matrix}Tr ( {F}_{t}^{T} {L}_{t} {F}_{t} ) + Tr ( {( {F}_{t} - {Y}_{t} )}^{T} U ( {F}_{t} - {Y}_{t} ) ) + \\ μ {Tr ( {( {P}_{t}^{T} {X}_{t} )}^{T} W + {1}_{n} {b}^{T} - {F}_{t} )}^{T} {D}_{t}^{( l )} ( {( {P}_{t}^{T} {X}_{t} )}^{T} W + {1}_{n} {b}^{T} - {F}_{t} )\end{matrix} ) + γ \text{} {‖ W ‖}_{F}^{2} ; \qquad ( 4 )$$

In Formula (4), Dₜ^{(l)} is a diagonal matrix, and an i^{th} element of the diagonal matrix is calculated as follows:

$${( {D}_{t}^{( l )} )}_{ii} = \frac{1}{2 {‖ {r}_{t}^{i} ‖}_{2}} ; \qquad ( 5 )$$

rₜⁱ is an i^{th} row of a matrix (Pₜ^{T}Xₜ)^{T}W+1ₙb^{T}−Fₜ.

Noting that Dₜ^{(l)} is related to Fₜ, Pₜ, W and b, it is extremely difficult to solve a problem of Formula (4). Therefore, to bypass this obstacle, an iterative method may be designed, to use fixed Dₜ^{(l)} obtained from the last iteration to obtain the solution. Through this method, the foregoing difficult problem can be solved, and Fₜ, Pₜ, W, and b are obtained.

Operation 1: First, perform derivation on b^{T} and make it equal to 0 according to Formula (4). A derivation formula is ∂(μTr((Pₜ^{T}Xₜ)^{T}W+1ₙb^{T}−Fₜ)^{T}Dₜ^{(l)}((Pₜ^{T}Xₜ)^{T}W+1ₙb^{T}−Fₜ))/∂b^{T}=0. First, ∂(μTr((Pₜ^{T}Xₜ)^{T}W+1ₙb^{T}−Fₜ)^{T}Dₜ^{(l)}((Pₜ^{T}Xₜ)^{T}W+1ₙb^{T}−Fₜ))/∂b^{T}=0 is expanded, and the third term in Formula (4) is involved. Then, derivation and simplification are performed on b^{T} related to b^{T} in the term, to obtain Formula (6):

$${1}_{n}^{T} {D}_{t}^{( l )} {1}_{n} {b}^{T} - {1}_{n}^{T} {D}_{t}^{( l )} {F}_{t} + {1}_{n}^{T} {D}_{t}^{( l )} {X}_{t}^{T} {P}_{t} W = 0 ; \qquad ( 6 )$$

b^{T} in Formula (6) is calculated as follows:

$${b}^{T} = \frac{{1}_{n}^{T} {D}_{t}^{( l )} ( {F}_{t} - {X}_{t}^{T} {P}_{t}^{W} )}{{1}_{n}^{T} {D}_{t}^{( l )} {1}_{n}} ; \qquad ( 7 )$$

Operation 2: Substitute a result of b^{T}, simplify an objective function (4), and then perform derivation on W and make it equal to 0. Similar to operation 1, expansion is first performed, and the latter two terms in the objective function are involved. Then, derivation and simplification are performed on W related to W in this expansion, to obtain Formula (8):

$$( μ {P}_{t}^{T} {X}_{t} {D}_{t}^{( l )} {X}_{t}^{T} {P}_{t} - 2 μ {P}_{t}^{T} {X}_{t} {D}_{t}^{( l )} {1}_{n} {( {1}_{n}^{T} {D}_{t}^{( l )} {1}_{n} )}^{- 1} {1}_{n}^{T} {D}_{t}^{( l )} {X}_{t}^{T} {P}_{t} + γ I ) W = μ ( {P}_{t}^{T} {X}_{t} {D}_{t}^{( l )} {F}_{t} - {P}_{t}^{T} {X}_{t} {D}_{t}^{( l )} {1}_{n} {( {1}_{n}^{T} {D}_{t}^{( l )} {1}_{n} )}^{- 1} {1}_{n}^{T} {D}_{t}^{( l )} {F}_{t} ) ; \qquad ( 8 )$$

For convenience in representation, let Hₜ=Dₜ^{(l)}1ₙ(1ₙ^{T}Dₜ^{(l)}1ₙ)⁻¹1ₙ^{T}Dₜ^{(l)}). Then, the above Formula (8) may be represented as Formula (9):

$$( μ {P}_{t}^{T} {X}_{t} {D}_{t}^{( l )} {X}_{t}^{T} {P}_{t} - 2 μ {P}_{t}^{T} {X}_{t} {H}_{t} {X}_{t}^{T} {P}_{t} + γ I ) W = μ ( {P}_{t}^{T} {X}_{t} {D}_{t}^{( l )} {F}_{t} - {P}_{t}^{T} {X}_{t} {H}_{t} {F}_{t} ) ; \qquad ( 9 )$$

W in Formula (9) is calculated as follows:

$$( 10 )$$

$$W = {μ ( μ {P}_{t}^{T} {X}_{t} {D}_{t}^{( l )} {X}_{t}^{T} {P}_{t} - 2 μ {P}_{t}^{T} {X}_{t} {H}_{t} {X}_{t}^{T} {P}_{t} + γ I )}^{- 1} ( {P}_{t}^{T} {X}_{t} {D}_{t}^{( l )} - {P}_{t}^{T} {X}_{t} {H}_{t} ) {F}_{t} ;$$

Further, for convenience in the next operation of calculating Pₜ, Aₜ is configured for representing the first half:

$$( 11 )$$

$${A}_{t} = {μ ( μ {P}_{t}^{T} {X}_{t} {D}_{t}^{( l )} {X}_{t}^{T} {P}_{t} - 2 μ {P}_{t}^{T} {X}_{t} {H}_{t} {X}_{t}^{T} {P}_{t} + γ I )}^{- 1} ( {P}_{t}^{T} {X}_{t} {D}_{t}^{( l )} - {P}_{t}^{T} {X}_{t} {H}_{t} ) ;$$

Calculation of W in Formula (10) is obtained as follows:

$$W = {A}_{t} {F}_{t} ; \qquad ( 12 )$$

Operation 3: Substitute the result of b^{T}, simplify the objective function (4), and perform derivation on Pₜ^{T} and make it equal to 0. It can be learned from the proposed algorithm and objective function that Pₜ^{T} and W affect each other and are correlated with each other. Therefore, during derivation and simplification performed on Pₜ^{T}, W is first considered as a constant, and then an iterative formula of Pₜ^{T} can be obtained through simplification.

Similar to operation 2, Pₜ^{T} is first expanded, and the third term in the objective function is involved. Then, derivation and simplification are performed on Pₜ^{T} related to Pₜ^{T} in the term, to obtain: WW^{T}Pₜ^{T}XₜDₜ^{(l)}Xₜ^{T}−WFₜ^{T}Dₜ^{(l)}Xₜ^{T}+WFₜ^{T}HₜXₜ^{T}−2WW^{T}Pₜ^{T}XₜHₜXₜ^{T}=0.

WW^{T}Pₜ^{T}Xₜ(Dₜ^{(l)}−2Hₜ)Xₜ^{T}=WFₜ^{T}(Dₜ^{(l)}−Hₜ)Xₜ^{T} is obtained through simplification, and Formula (13) is calculated as follows:

$${P}_{t}^{T} = {( {W}^{T} )}^{- 1} {F}_{t}^{T} ( {D}_{t}^{( l )} - {H}_{t} ) {X}_{t}^{T} {X}_{t} ( {D}_{t}^{( l )} - 2 {H}_{t} ) {X}_{t}^{T} ; \qquad ( 13 )$$

For convenience in representation, Bₜ is configured for representing the second half:

$${B}_{t} = ( {D}_{t}^{( l )} - {H}_{t} ) {X}_{t}^{T} {X}_{t} ( {D}_{t}^{( l )} - 2 {H}_{t} ) {X}_{t}^{T} ; \qquad ( 14 )$$

Pₜ^{T} may be represented as Pₜ^{T}=(W^{T})⁻¹Fₜ^{T}Bₜ. Formula (12) is substituted into Pₜ^{T}=(W^{T})⁻¹Fₜ^{T}Bₜ and an expression of Pₜ^{T} is obtained through simplification.

$${P}_{t}^{T} = {( {A}_{t}^{T} )}^{- 1} {B}_{t} ; \qquad ( 15 )$$

Operation 4: Substitute results of b^{T}, W and Pₜ^{T}, simplify the objective function (4), and then perform derivation on Fₜ and make it equal to 0. Similar to operation 3, expansion is first performed, and the first three terms in the objective function are involved. Then, derivation and simplification are performed on Fₜ related to Fₜ in this expansion, to obtain Formula (16):

$$( 16 )$$

$${L}_{t} {F}_{t} + ( {UF}_{t} - {UY}_{t} ) - μ ( {B}_{t} {X}_{t} {D}_{t}^{( l )} {F}_{t} + {D}_{t}^{( l )} {X}_{t}^{T} {B}_{t}^{T} {F}_{t} - {D}_{t}^{( l )} {F}_{t} + 2 {H}_{t} {F}_{t} - {B}_{t} {X}_{t} {H}_{t} {F}_{t} - {H}_{t} {X}_{t}^{T} {B}_{t}^{T} {F}_{t} ) = 0$$

The following Formula (17) is obtained through further simplification:

$$( 17 )$$

$$( {L}_{t} + U - μ {B}_{t} {XD}_{t}^{( l )} - μ {D}_{t}^{( l )} {X}_{t}^{T} {B}_{t}^{T} + μ {D}_{t}^{( l )} - 2 μ {H}_{t} + μ {B}_{t} {XH}_{t} + μ {H}_{t} {X}_{t}^{T} {B}_{t}^{T} ) {F}_{t} = {UY}_{t} ;$$

Fₜ=(Lₜ+U+μ(Dₜ^{(l)}+BₜXₜHₜ+HₜXₜ^{T}Bₜ^{T}−BₜXₜDₜ^{(l)}−Dₜ^{(l)}Xₜ^{T}Bₜ^{T}−2Hₜ))⁻¹UYₜ is obtained through calculation. For convenience in representation, let:

$${M}_{t} = {( {L}_{t} + U + μ ( {D}_{t}^{( l )} + {B}_{t} {X}_{t} {H}_{t} + {H}_{t} {X}_{t}^{T} {B}_{t}^{T} - {B}_{t} {X}_{t} {D}_{t}^{( l )} - {D}_{t}^{( l )} {X}_{t}^{T} {B}_{t}^{T} - 2 {H}_{t} ) )}^{- 1} ; \qquad ( 18 )$$

$${Q}_{t} = {UY}_{t} ; \qquad ( 19 )$$

Then, Fₜ may be represented as Formula (20):

$${F}_{t} = {M}_{t} {Q}_{t} ; \qquad ( 20 )$$

Summary: Operation 1 to operation 4 above provide a solving process of Fₜ, Pₜ, W, and b, and the objective function (4) is obtained based on the foregoing conversion. The identification label matrix Fₜ, the sample projection matrix Pₜ, the label projection matrix W, and the bias term b can be obtained, based on the iterative method, in sequence through the foregoing solving process.

In combination with the foregoing iterative process, an overall algorithm procedure of Pₜ, W, and b^{T} is obtained by using a plurality of training samples, and is briefly summarized as follows:

Input: A training sample matrix of the t^{th} view is expressed as Xₜ∈R^{d}^{ₜ}^{×n}, and a signature matrix of a training sample is Y∈R^{n×c}.

First, random initialization is performed on Fₜ, Pₜ, W, and b, and t=1, 2, 3, . . . m.

Second, a Laplacian matrix Lₜ of the t^{th} view is obtained through calculation according to Formula (3).

Third, iteration is performed.
(a) Formula (5) is calculated according to Dₜ^{(l)}, a value of Dₜ^{(l)} is obtained, and t=1, 2, 3, . . . m.
(b) Cyclic calculation is performed when t=1, 2, 3, . . . m;
Hₜ=Dₜ^{(l)}1ₙ(1ₙ^{T}Dₜ^{(l)}1ₙ)⁻¹1ₙ^{T}Dₜ^{(l)} is calculated first;
then, Aₜ, Bₜ, Mₜ, and Qₜ are calculated according to Formula (11), Formula (14), Formula (18), and Formula (19) respectively; and
next, Fₜ and Pₜ are updated according to Formula (20) and Formula (15) respectively;
(c) W and b^{T} are updated according to Formula (12) and Formula (7).

Fourth, a result is returned until Fₜ, Pₜ, W, and b^{T} converge, and t=1, 2, 3, . . . m.

Output: A classification parameter matrix is optimized. In other words, the label projection matrix is W∈R^{n×c}.

After Pₜ, W, and b^{T} are obtained, a test process is as follows:

A specific proportion of samples are first selected as training samples at the beginning of an experiment, and the remaining part is used as a test sample. Herein, the following method is used for a classification process of the test sample: By using a definition of an objective function formula in which a regularization term includes calculation related to a sample class label, and the test sample is substituted into (Pₜ^{T} Zₜ)^{T}W+1ₙb^{T} of the formula. Zₜ represents a test sample of the t^{th} view. In this way, the class label corresponding to the test sample and a class label of the training sample obtained through iterative training can be obtained, and the class label is compared with an actual sample class label. Note: When the sample class labels are compared, the training samples do not need to be compared again herein, and only the test samples need to be compared. After Pₜ^{T}, W, and b^{T} are obtained through training, a class label of a new test sample is directly solved as follows:

$$\hat{F} = \frac{1}{m} ( {\sum }_{t = 1}^{m} {( {P}_{t}^{T} {Z}_{t} )}^{T} W + {1}_{n} {b}^{T} ) ; \qquad ( 21 )$$

Herein, in the experiment, the identification label matrix Fₜ obtained through the iterative training and a real sample label matrix Yₜ have different compositions, resulting in a plurality of decimal numbers between −1 and 1 in Fₜ. A processing method is a threshold comparison method. 0 is used as a threshold, greater than 0 is set to 1, and less than 0 is set to −1. The numbers are also changed into a matrix Yₜ with only −1s and 1s in a real sample label format.

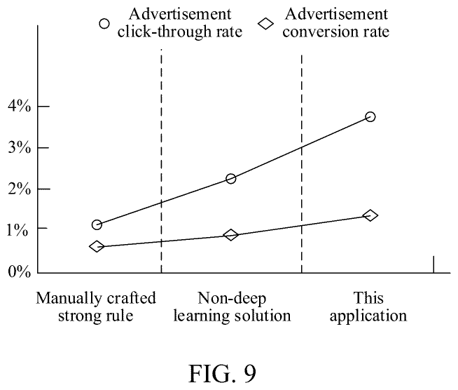

FIG. 9 is a schematic diagram of an advertisement click-through rate and an advertisement conversion rate after a paid advertisement is delivered to a predicted user with a propensity to pay by using an user identification method according to this application.

A manually crafted strong rule and a non-deep learning solution are two related technologies for user identification. It can be learned from FIG. 9 that, in view of the advertisement click-through rate, in this application, compared with other related technologies, the advertisement click-through rate is improved by 182.7% on average; and in view of the advertisement conversion rate, in this application, compared with other technical solutions, the advertisement conversion rate is improved by 178.41% on average.

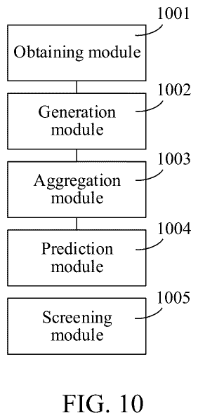

FIG. 10 shows a block diagram of a structure of an user identification apparatus according to an embodiment of this application, and the apparatus includes:
an obtaining module 1001, configured to obtain a plurality of users of an application program;
a generation module 1002, configured to generate, for any one of the plurality of users, an account feature and a service feature of the user, the account feature being generated based on basic information of the user, and the service feature being generated based on a historical payment-related behavior of the user;
an aggregation module 1003, configured to: aggregate account features in a plurality of time dimensions to obtain a target account feature; and aggregate service features in the plurality of time dimensions to obtain a target service feature;
the generation module 1002, further configured to generate an user feature of the user based on the target account feature and the target service feature; and
a identification module 1004, configured to input user features of the plurality of users into a classifier to obtain a predicted classification result, the predicted classification result being configured for indicating whether the plurality of users are users with a propensity to pay.

In an embodiment, the account feature includes a first-type account feature and a second-type account feature. The apparatus further includes an encoding module. The encoding module is configured to: perform, based on values of a plurality of first-type account features respectively corresponding to the plurality of users, unified encoding on first-type account features having values in a same value range in the plurality of first-type account features, to obtain an encoded first-type account feature; and perform, based on types of a plurality of second-type account features of the plurality of users, unified encoding on second-type account features belonging to a same category in the plurality of second-type account features, to obtain an encoded second-type account feature.

In an embodiment, the aggregation module 1003 is further configured to: aggregate encoded first-type account features in the plurality of time dimensions, to obtain a target first-type account feature; and aggregate encoded second-type account features in the plurality of time dimensions, to obtain a target second-type account feature.

In an embodiment, the generation module 1002 is further configured to generate the user feature of the user based on the target first-type account feature, the target second-type account feature, and the target service feature.

In an embodiment, the service feature includes a first-type service feature and a second-type service feature. The apparatus further includes an encoding module. The encoding module is configured to: perform, based on values of a plurality of first-type service features respectively corresponding to the plurality of users, unified encoding on first-type service features having values in a same value range in the plurality of first-type service features, to obtain an encoded first-type service feature; and perform, based on types of a plurality of second-type service features of the plurality of users, unified encoding on second-type service features belonging to a same category in the plurality of second-type service features, to obtain an encoded second-type service feature.

In an embodiment, the aggregation module 1003 is further configured to: aggregate encoded first-type service features in the plurality of time dimensions, to obtain a target first-type service feature; and aggregate encoded second-type service features in the plurality of time dimensions, to obtain a target second-type service feature.

In an embodiment, the generation module 1002 is further configured to generate the user feature of the user based on the target account feature, the target first-type service feature, and the target second-type service feature.

In an embodiment, the apparatus further includes a screening module 1005. The screening module 1005 is configured to: obtain a plurality of seed users of the application program; screen the plurality of seed users based on an anomaly indicator of the plurality of seed users; and determine a seed user obtained through screening as the user of the application program.

In an embodiment, the application program includes online meeting software. The screening module 1005 is further configured to group the plurality of seed users to obtain a plurality of groups; and a variance determination process is performed on any one of the plurality of groups. The variance determination process includes: obtaining, for one seed user in an i^{th} group of the plurality of groups, duration for which the seed user uses the online meeting software within a first duration range; calculating a variance of use duration of a plurality of seed users in the i^{th} group, the i^{th} group being any one of the plurality of groups; and removing all seed users in the i^{th} group when the variance is greater than a first variance value; or retaining all seed users in the i^{th} group when the variance is not greater than a first variance value.

In an embodiment, the application program includes online meeting software. The screening module 1005 is further configured to group the plurality of seed users to obtain a plurality of groups; and a variance determination process is performed on any one of the plurality of groups. The variance determination process includes: obtaining, for one seed user in an i^{th} group of the plurality of groups, a quantity of times that the seed user participates in an online meeting through the online meeting software within a second duration range; calculating a variance of times of participation of a plurality of seed users in the i^{th} group, the i^{th} group being any one of the plurality of groups; and removing all seed users in the i^{th} group when the variance is greater than a second variance value; or retaining all seed users in the i^{th} group when the variance is not greater than a second variance value.

In an embodiment, the application program includes online meeting software. The screening module 1005 is further configured to group the plurality of seed users to obtain a plurality of groups; and a variance determination process is performed on any one of the plurality of groups. The variance determination process includes: obtaining, for one seed user in an i^{th} group of the plurality of groups, a duration distribution status in which the seed user participates in an online meeting through the online meeting software within a third duration range, the duration distribution status indicating duration for which the seed user participates in a meeting each time and a total quantity of times of participation; calculating a duration variance of duration for which a plurality of seed users in the i^{th} group participate in the meeting each time; calculating a times variance of the total quantity of times of participation of the plurality of seed users in the i^{th} group; and removing all seed users in the i^{th} group when the duration variance is greater than a third variance value and the times variance is greater than a fourth variance value; or retaining all seed users in the i^{th} group when the duration variance is not greater than a third variance value or the times variance is not greater than a fourth variance value.

In an embodiment, the identification module 1004 is further configured to: generate, based on the plurality of user features, view features of the plurality of users in m views; generate, for a t^{th} view of the m views, a t^{th} predicted payment label matrix based on a plurality of view features respectively corresponding to the plurality of users in the t^{th} view in combination with a t^{th} projection matrix obtained through pre-training; calculate a mean of m predicted payment label matrices in the m views; and determine the mean as the predicted classification result, the t^{th} projection matrix being configured for aligning the t^{th} view and another view to same projection space, and the another view including a view other than the t^{th} view of the m views.

In an embodiment, the identification module 1004 is further configured to: input, for one of the plurality of user features, the user feature into an encoder, to obtain a low-dimensional user feature; input the low-dimensional user feature into a decoder, to obtain a high-dimensional user feature; calculate an error between the user feature and the high-dimensional user feature; adjust the encoder and the decoder based on the error when the error does not reach a convergence condition; determine the high-dimensional user feature as the user feature; re-perform inputting the user feature into the encoder, to obtain a low-dimensional user feature; input the low-dimensional user feature into the decoder, to obtain a high-dimensional user feature; and calculate an error between the user feature and the high-dimensional user feature; or output the low-dimensional user feature when the error reaches a convergence condition; and cluster the plurality of users based on a plurality of low-dimensional user features corresponding to the plurality of user features, to obtain the predicted classification result.

In an embodiment, the identification module 1004 is further configured to: generate, based on the plurality of user features, view features of the plurality of users in m views; obtain, through training for a t^{th} view of the m views, a t^{th} projection matrix based on a plurality of view features respectively corresponding to the plurality of users in the t^{th} view and payment labels of some of the plurality of users; generate a target projection matrix based on m projection matrices corresponding to the m views, the target projection matrix being configured for indicating a plurality of target user features respectively corresponding to the plurality of users; input, for one of the plurality of target user features, the target user feature into an encoder, to obtain a low-dimensional target user feature; input the low-dimensional target user feature into a decoder, to obtain a high-dimensional target user feature; calculate an error between the target user feature and the high-dimensional target user feature; adjust the encoder and the decoder based on the error when the error does not reach a convergence condition; determine the high-dimensional user feature as the target user feature; re-perform inputting the target user feature into the encoder, to obtain a low-dimensional target user feature; input the low-dimensional target user feature into the decoder, to obtain a high-dimensional target user feature; and calculate an error between the target user feature and the high-dimensional target user feature; or output the low-dimensional target user feature when the error reaches a convergence condition; and cluster the plurality of users based on a plurality of low-dimensional target user features corresponding to the plurality of target user features, to obtain the predicted classification result, the t^{th} projection matrix being configured for aligning the t^{th} view and another view to same projection space, and the another view including a view other than the t^{th} view of the m views.

In conclusion, the account features and the service features in the plurality of time dimensions are aggregated, so that accuracy of predicting whether the user of the application program has the propensity to pay is improved. The plurality of time dimensions enrich manners of constructing the user feature and improve a coverage breadth of the user feature. In addition, aggregation reduces a feature dimension of sparse high-dimensional user feature space and improves an expression capability of the user feature. Therefore, aggregating the plurality of time dimensions can retain beneficial effects brought by the plurality of time dimensions. In addition, a dimensional disaster problem is avoided.

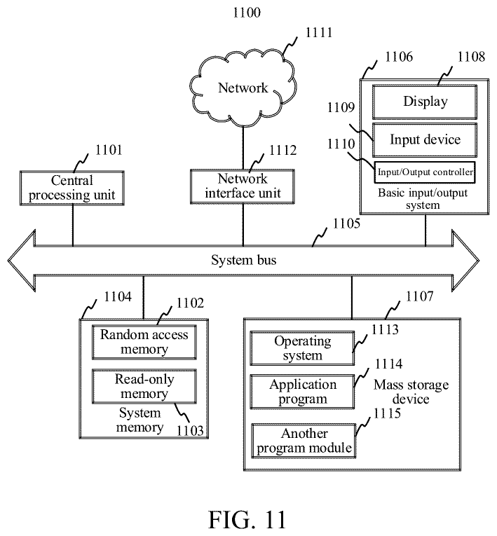

FIG. 11 is a schematic diagram of a structure of a computer device according to an embodiment. The computer device 1100 includes a central processing unit (CPU) 1101, a system memory 1104 including a random access memory (RAM) 1102 and a read-only memory (ROM) 1103, and a system bus 1105 connecting the system memory 1104 and the central processing unit 1101. The computer device 1100 further includes a basic input/output system (I/O system) 1106 assisting in transmitting information between components in the computer device, and a mass storage device 1107 configured for storing an operating system 1113, an application program 1114, and another program module 1115.

The basic input/output system 1106 includes a display 1108 configured for displaying information and an input device 1109, such as a mouse or a keyboard, that is configured for inputting information by a user. The display 1108 and the input device 1109 are both connected to the central processing unit 1101 via an input/output controller 1110 connected to the system bus 1105. The basic input/output system 1106 may further include the input/output controller 1110, configured for receiving and processing inputs from a plurality of other devices such as a keyboard, a mouse, and an electronic stylus. Similarly, the input/output controller 1111 further provides an output to a display screen, a printer, or another type of output device.

The mass storage device 1107 is connected to the central processing unit 1101 via a mass storage controller (not shown) connected to the system bus 1105. The mass storage device 1107 and a computer device-readable medium associated with the mass storage device 1107 provide non-volatile storage for the computer device 1100. That is, the mass storage device 1107 may include a computer device-readable medium (not shown) such as a hard disk drive or a compact disc read-only memory (CD-ROM) drive.

In general, the computer device-readable medium may include a computer device storage medium and a communication medium. The computer device storage medium includes volatile and non-volatile media, and removable and non-removable media implemented by using any method or technology configured for storing information such as computer device-readable instructions, data structures, program modules, or other data. The computer device storage medium includes a RAM, a ROM, an erasable programmable read-only memory (EPROM), an electrically erasable programmable read-only memory (EEPROM), a CD-ROM, a digital video disc (DVD) or another optical memory, a tape cartridge, a magnetic cassette, a magnetic disk memory, or another magnetic storage device. Certainly, a person skilled in the art may learn that the computer device storage medium is not limited to the foregoing several types. The system memory 1104 and the mass storage device 1107 may be collectively referred to as a memory.

According to various embodiments of the present disclosure, the computer device 1100 may further be connected, through a network such as the Internet, to a remote computer device on the network and run. That is, the computer device 1100 may be connected to a network 1111 via a network interface unit 1112 connected to the system bus 1105, or may be connected to another type of network or a remote computer device system (not shown) via the network interface unit 1112.

The memory further includes one or more programs. The one or more programs are stored in the memory. The central processing unit 1101 implements all or some of the operations of the user identification method by executing the one or more programs.

This application further provides a computer-readable storage medium. The storage medium has at least one instruction stored therein, and the at least one instruction is loaded and executed by a processor to implement the user identification method according to the foregoing method embodiments.

An embodiment of this application further provides a computer program product including a computer program. When the computer program product runs on a computer, the computer is enabled to perform the user identification method according to the foregoing embodiments.

The sequence numbers of the foregoing embodiments of this application are merely for description purposes but do not imply the preference among embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely embodiments of this application, but are not intended to limit this application. Any modification, equivalent replacement, or improvement made within the spirit and principle of this application shall fall within the protection scope of this application.

What is claimed is:

1. A user identification method, performed by a computer device, and comprising:
obtaining a plurality of users of an application program;
generating, an account feature and a service feature of a user from the plurality of users, the account feature being based on account use information of the user in the application program, and the service feature being based on a historical payment-related behavior of the user;
aggregating account features in a plurality of time dimensions to obtain a target account feature;
aggregating service features in the plurality of time dimensions to obtain a target service feature;
generating an user feature of the user based on the target account feature and the target service feature; and
inputting user features of the plurality of users into a classifier to obtain a predicted classification result, the predicted classification result indicating whether the plurality of users are users with a propensity to pay.

2. The method according to claim 1, wherein the account feature comprises a first-type account feature and a second-type account feature;
and the method further comprises:
performing, based on values of first-type account features respectively corresponding to the plurality of users, unified encoding on first-type account features having values in a same value range in the plurality of first-type account features, to obtain an encoded first-type account feature; and
performing, based on a type of the second-type account feature, unified encoding on second-type account features belonging to a same category in the plurality of second-type account features, to obtain an encoded second-type account feature;
the aggregating account features in a plurality of time dimensions to obtain a target account feature comprises:
aggregating encoded first-type account features in the plurality of time dimensions, to obtain a target first-type account feature; and
aggregating encoded second-type account features in the plurality of time dimensions, to obtain a target second-type account feature; and
the generating a user feature of the user based on the target account feature and the target service feature comprises generating the user feature of the user based on the target first-type account feature, the target second-type account feature, and the target service feature.

3. The method according to claim 1, the service feature comprises a first-type service feature and a second-type service feature; and the method further comprises:
performing, based on values of first-type service features respectively corresponding to the plurality of users, unified encoding on first-type service features having values in a same value range in the plurality of first-type service features, to obtain an encoded first-type service feature; and
performing, based on a type of the second-type service feature, unified encoding on second-type service features belonging to a same category in the plurality of second-type service features, to obtain an encoded second-type service feature;
the aggregating service features in the plurality of time dimensions to obtain a target service feature comprises:
aggregating encoded first-type service features in the plurality of time dimensions, to obtain a target first-type service feature; and
aggregating encoded second-type service features in the plurality of time dimensions, to obtain a target second-type service feature; and
the generating an user feature of the user based on the target account feature and the target service feature comprises generating the user feature of the user based on the target account feature, the target first-type service feature, and the target second-type service feature.

4. The method according to claim 1, before the obtaining a plurality of users of an application program, comprising:
obtaining a plurality of seed users of the application program;
screening the plurality of seed users based on an anomaly indicator of the plurality of seed users; and
determining a seed user obtained through screening as the user of the application program.

5. The method according to claim 4, wherein the application program comprises online meeting software; the screening the plurality of seed users based on an anomaly indicator of the plurality of seed users comprise:
grouping the plurality of seed users to obtain a plurality of groups; and determining variance of any one of the plurality of groups to screen the plurality of seed users; and the variance determination comprises:
obtaining, for one seed user in an i^{th} group of the plurality of groups, duration for which the seed user uses the online meeting software within a first duration range; calculating a variance of use duration of all seed users in the i^{th} group, the i^{th} group being any one of the plurality of groups; and
removing all the seed users in the i^{th} group when the variance is greater than a first variance value; or
retaining all the seed users in the i^{th} group when the variance is not greater than a first variance value.

6. The method according to claim 4, wherein the screening the plurality of seed users based on an anomaly indicator of the plurality of seed users comprise:
grouping the plurality of seed users to obtain a plurality of groups; and determining variance of any one of the plurality of groups to screen the plurality of seed users; and the variance determination comprises:
obtaining, for one seed user in an i^{th} group of the plurality of groups, a quantity of times that the seed user participates in an online meeting through online meeting software within a second duration range; calculating a variance of times of participation of all seed users in the i^{th} group, the i^{th} group being any one of the plurality of groups; and
removing all the seed users in the i^{th} group when the variance is greater than a second variance value; or
retaining all the seed users in the i^{th} group when the variance is not greater than a second variance value.

7. The method according to claim 4, wherein the screening the plurality of seed users based on an anomaly indicator of the plurality of seed users comprise:
grouping the plurality of seed users to obtain a plurality of groups; and
determining variance of any one of the plurality of groups to screen the plurality of seed users; and the variance determination comprises:
obtaining, for one seed user in an i^{th} group of the plurality of groups, a duration distribution status in which the seed user participates in an online meeting through online meeting software within a third duration range, the duration distribution status indicating duration for which the seed user participates in a meeting each time and a total quantity of times of participation;
calculating a duration variance of duration for which all seed users in the i^{th} group participate in the meeting each time; calculating a times variance of the total quantity of times of participation of all the seed users in the i^{th} group; and
removing all the seed users in the i^{th} group when the duration variance is greater than a third variance value and the times variance is greater than a fourth variance value; or
retaining all the seed users in the i^{th} group when the duration variance is not greater than a third variance value or the times variance is not greater than a fourth variance value.

8. The method according to claim 1, wherein the inputting a plurality of user features into a classifier to obtain a predicted classification result comprises:
generating, based on the plurality of user features, view features of the plurality of users in m views, the view features in different views corresponding to different identifier dimensions of the users;
generating, for a t^{th} view of the m views, a t^{th} predicted payment label matrix based on view features respectively corresponding to the plurality of users in the t^{th} view in combination with a t^{th} projection matrix obtained through pre-training;
calculating a mean of m predicted payment label matrices in the m views; and
determining the mean as the predicted classification result,
the t^{th} projection matrix being configured for aligning the t^{th} view and another view to same projection space, and the another view comprising a view other than the t^{th} view of the m views.

9. The method according to claim 1, wherein the inputting a plurality of user features into a classifier to obtain a predicted classification result comprises:
inputting, for one of the plurality of user features, the user feature into an encoder, to obtain a low-dimensional user feature; inputting the low-dimensional user feature into a decoder, to obtain a high-dimensional user feature; calculating an error between the user feature and the high-dimensional user feature;
adjusting the encoder and the decoder based on the error when the error does not reach a convergence condition; determining the high-dimensional user feature as the user feature; re-performing the inputting the user feature into an encoder, to obtain a low-dimensional user feature; inputting the low-dimensional user feature into a decoder, to obtain a high-dimensional user feature; and calculating an error between the user feature and the high-dimensional user feature; or
outputting the low-dimensional user feature when the error reaches a convergence condition; and
clustering the plurality of users based on a plurality of low-dimensional user features corresponding to the plurality of user features, to obtain the predicted classification result.

10. The method according to claim 1, wherein the inputting a plurality of user features into a classifier to obtain a predicted classification result comprises:
generating, based on the plurality of user features, view features of the plurality of users in m views;
obtaining, through training for a t^{th} view of the m views, a t^{th} projection matrix based on view features respectively corresponding to the plurality of users in the t^{th} view and payment labels of some of the plurality of users;
generating a target projection matrix based on m projection matrices corresponding to the m views, the target projection matrix being configured for indicating a plurality of target user features respectively corresponding to the plurality of users;
inputting, for one of the plurality of target user features, the target user feature into an encoder, to obtain a low-dimensional target user feature; inputting the low-dimensional target user feature into a decoder, to obtain a high-dimensional target user feature; calculating an error between the target user feature and the high-dimensional target user feature;
adjusting the encoder and the decoder based on the error when the error does not reach a convergence condition; determining the high-dimensional user feature as the target user feature; re-performing the inputting the target user feature into an encoder, to obtain a low-dimensional target user feature; inputting the low-dimensional target user feature into a decoder, to obtain a high-dimensional target user feature; and calculating an error between the target user feature and the high-dimensional target user feature; or
outputting the low-dimensional target user feature when the error reaches a convergence condition; and
clustering the plurality of users based on a plurality of low-dimensional target user features corresponding to the plurality of target user features, to obtain the predicted classification result,
the t^{th} projection matrix being configured for aligning the t^{th} view and another view to same projection space, and the another view comprising a view other than the t^{th} view of the m views.

11. A computer device, comprising: a processor and a memory, the memory having a computer program stored therein, and the computer program being loaded and executed by the processor to implement a user identification method, comprising:
obtaining a plurality of users of an application program;
generating, an account feature and a service feature of a user from the plurality of users, the account feature being based on account use information of the user in the application program, and the service feature being based on a historical payment-related behavior of the user;
aggregating account features in a plurality of time dimensions to obtain a target account feature;
aggregating service features in the plurality of time dimensions to obtain a target service feature;
generating a user feature of the user based on the target account feature and the target service feature; and
inputting user features of the plurality of users into a classifier to obtain a predicted classification result, the predicted classification result indicating whether the plurality of users are users with a propensity to pay.

12. The computer device according to claim 11, wherein the account feature comprises a first-type account feature and a second-type account feature;
and the method further comprises:
performing, based on values of first-type account features respectively corresponding to the plurality of users, unified encoding on first-type account features having values in a same value range in the plurality of first-type account features, to obtain an encoded first-type account feature; and
performing, based on a type of the second-type account feature, unified encoding on second-type account features belonging to a same category in the plurality of second-type account features, to obtain an encoded second-type account feature;
the aggregating account features in a plurality of time dimensions to obtain a target account feature comprises:
aggregating encoded first-type account features in the plurality of time dimensions, to obtain a target first-type account feature; and
aggregating encoded second-type account features in the plurality of time dimensions, to obtain a target second-type account feature; and
the generating a user feature of the user based on the target account feature and the target service feature comprises generating the user feature of the user based on the target first-type account feature, the target second-type account feature, and the target service feature.

13. The computer device according to claim 11, wherein the service feature comprises a first-type service feature and a second-type service feature; and the method further comprises:
performing, based on values of first-type service features respectively corresponding to the plurality of users, unified encoding on first-type service features having values in a same value range in the plurality of first-type service features, to obtain an encoded first-type service feature; and
performing, based on a type of the second-type service feature, unified encoding on second-type service features belonging to a same category in the plurality of second-type service features, to obtain an encoded second-type service feature;
the aggregating service features in the plurality of time dimensions to obtain a target service feature comprises:
aggregating encoded first-type service features in the plurality of time dimensions, to obtain a target first-type service feature; and
aggregating encoded second-type service features in the plurality of time dimensions, to obtain a target second-type service feature; and
the generating a user feature of the user based on the target account feature and the target service feature comprises generating the user feature of the user based on the target account feature, the target first-type service feature, and the target second-type service feature.

14. The computer device according to claim 11, wherein before the obtaining a plurality of users of an application program, comprising:
obtaining a plurality of seed users of the application program;
screening the plurality of seed users based on an anomaly indicator of the plurality of seed users; and
determining a seed user obtained through screening as the user of the application program.

15. The computer device according to claim 14, wherein the application program comprises online meeting software; the screening the plurality of seed users based on an anomaly indicator of the plurality of seed users comprises:
grouping the plurality of seed users to obtain a plurality of groups; and determining variance of any one of the plurality of groups to screen the plurality of seed users; and the variance determination comprises:
obtaining, for one seed user in an i^{th} group of the plurality of groups, duration for which the seed user uses the online meeting software within a first duration range; calculating a variance of use duration of all seed users in the i^{th} group, the i^{th} group being any one of the plurality of groups; and
removing all the seed users in the i^{th} group when the variance is greater than a first variance value; or
retaining all the seed users in the i^{th} group when the variance is not greater than a first variance value.

16. The computer device according to claim 14, wherein the screening the plurality of seed users based on an anomaly indicator of the plurality of seed users comprises:
grouping the plurality of seed users to obtain a plurality of groups; and determining variance of any one of the plurality of groups to screen the plurality of seed users; and the variance determination comprises:
obtaining, for one seed user in an i^{th} group of the plurality of groups, a quantity of times that the seed user participates in an online meeting through online meeting software within a second duration range; calculating a variance of times of participation of all seed users in the i^{th} group, the i^{th} group being any one of the plurality of groups; and
removing all the seed users in the i^{th} group when the variance is greater than a second variance value; or
retaining all the seed users in the i^{th} group when the variance is not greater than a second variance value.

17. The computer device according to claim 14, wherein the screening the plurality of seed users based on an anomaly indicator of the plurality of seed users comprises:
grouping the plurality of seed users to obtain a plurality of groups; and
determining variance of any one of the plurality of groups to screen the plurality of seed users; and the variance determination comprises:
obtaining, for one seed user in an i^{th} group of the plurality of groups, a duration distribution status in which the seed user participates in an online meeting through online meeting software within a third duration range, the duration distribution status indicating duration for which the seed user participates in a meeting each time and a total quantity of times of participation;
calculating a duration variance of duration for which all seed users in the i^{th} group participate in the meeting each time; calculating a times variance of the total quantity of times of participation of all the seed users in the i^{th} group; and
removing all the seed users in the i^{th} group when the duration variance is greater than a third variance value and the times variance is greater than a fourth variance value; or
retaining all the seed users in the i^{th} group when the duration variance is not greater than a third variance value or the times variance is not greater than a fourth variance value.

18. The computer device according to claim 11, wherein the inputting a plurality of user features into a classifier to obtain a predicted classification result comprises:
generating, based on the plurality of user features, view features of the plurality of users in m views, the view features in different views corresponding to different identifier dimensions of the users;
generating, for a t^{th} view of the m views, a t^{th} predicted payment label matrix based on view features respectively corresponding to the plurality of users in the t^{th} view in combination with a t^{th} projection matrix obtained through pre-training;
calculating a mean of m predicted payment label matrices in the m views; and
determining the mean as the predicted classification result,
the t^{th} projection matrix being configured for aligning the t^{th} view and another view to same projection space, and the another view comprising a view other than the t^{th} view of the m views.

19. The computer device according to claim 11, wherein the inputting a plurality of user features into a classifier to obtain a predicted classification result comprises:
inputting, for one of the plurality of user features, the user feature into an encoder, to obtain a low-dimensional user feature; inputting the low-dimensional user feature into a decoder, to obtain a high-dimensional user feature; calculating an error between the user feature and the high-dimensional user feature;
adjusting the encoder and the decoder based on the error when the error does not reach a convergence condition; determining the high-dimensional user feature as the user feature; re-performing the inputting the user feature into an encoder, to obtain a low-dimensional user feature; inputting the low-dimensional user feature into a decoder, to obtain a high-dimensional user feature; and calculating an error between the user feature and the high-dimensional user feature; or
outputting the low-dimensional user feature when the error reaches a convergence condition; and
clustering the plurality of users based on a plurality of low-dimensional user features corresponding to the plurality of user features, to obtain the predicted classification result.

20. A non-transitory computer-readable storage medium, having a computer program stored therein, and the computer program being loaded and executed by a processor to implement a user identification method, comprising:
obtaining a plurality of users of an application program;
generating, an account feature and a service feature of a user from the plurality of users, the account feature being based on account use information of the user in the application program, and the service feature being based on a historical payment-related behavior of the user;
aggregating account features in a plurality of time dimensions to obtain a target account feature;
aggregating service features in the plurality of time dimensions to obtain a target service feature;
generating a user feature of the user based on the target account feature and the target service feature; and
inputting user features of the plurality of users into a classifier to obtain a predicted classification result, the predicted classification result indicating whether the plurality of users are users with a propensity to pay.
